(19) United States
(12) Patent Application Publication
(10) Pub. No.: US 2006/0050580 A1
(43) Pub. Date: Mar. 9, 2006

(54) Method for generating identification code of semiconductor device, method for identifying semiconductor device and semiconductor device

(75) Inventors: Yoshiaki Yamaguchi, Niigata (JP); Tatsuya Furukawa, Niigata (JP); Koichi Shimokawa, Niigata (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/196,395

(22) Filed: Aug. 4, 2005

(30) Foreign Application Priority Data
Aug. 23, 2004 (JP) 2004-241987

(51) Int. Cl. G06F 3/00

(52) U.S. Cl. 365/201; 365/226; 710/16

(57) ABSTRACT

A semiconductor device including memory cells such as flip-flops, RAMs or SRAMs is powered on, and first logic signals of Hi or Lo output from the respective memory cells are obtained. A combination of the logic signals is used as a unique identification code for identifying a semiconductor device.

### CROSS-REFERENCE TO RELATED APPLICATION

The disclosure of Japanese Patent Application No. 2004-241987 filed on Aug. 23, 2004 including specification, drawings and claims is incorporated herein by reference in its entirety.

### BACKGROUND OF THE INVENTION

The present invention relates to a method for generating an identification code of a semiconductor device in which a large number of circuits outputting binary values of Hi/Lo, e.g., flip-flops or random access memories (RAMs), are formed on a substrate, a method for identifying a semiconductor device, and a semiconductor device.

In management of a fabrication process of a semiconductor integrated circuit and failure analysis of the circuit, it is necessary to identify individual dies (chips) formed out of a semiconductor substrate. For example, to analyze a cause of a failure of an integrated circuit after shipment and take measures against the failure, examination going back to history of a semiconductor fabrication process or an assembly and packaging process is needed. To find a cause in the fabrication process, conditions of processing on a chip having a failure are determined by identifying a period in which the chip is fabricated, a lot and a wafer including the chip and the position of the chip in the wafer. To enable such identifications, semiconductor devices (chips or dies) are provided with identification numbers or symbols unique to the respective semiconductor devices before shipment.

Conventional methods for identifying semiconductor devices include a method with which identification information is stored in a device identification pattern formed on a semiconductor chip by using a laser trimmer and a method with which identification information on a semiconductor chip is written in a nonvolatile memory incorporated in this chip. In Japanese Unexamined Patent Publication (Kokai) No. 2003-203832, a method for providing identification numbers by utilizing variations in characteristics of TFTs formed on a substrate having an insulating surface is disclosed. According to this method, a substrate identification circuit including proper bit generating circuits each outputting a one-bit random number based on variations in characteristics of TFTs is formed on a chip, and a one-bit random number is generated to produce a numeric value proper to the chip, so that the numeric value is used as an identification number.

In the method with which identification information on individual semiconductor devices is stored by using a laser trimmer, however, laser trimmer apparatus needs to be introduced and operation of writing information is complicated. In the method using a nonvolatile memory, a process for the nonvolatile memory has to be added even in a semiconductor device for which no nonvolatile memory is inherently needed. Therefore, either method consumes time and cost.

In the method disclosed in Japanese Unexamined Patent Publication (Kokai) No. 2003-203832, TFTs, which a semiconductor device inherently includes, are utilized, and thus the cost is low. However, this method is limited to identification of a semiconductor device that includes TFTs formed on a substrate having an insulating surface. Therefore, the method has a drawback of incapability of being used as a method for identifying a general semiconductor device constituted by MOS transistors or bipolar transistors formed on a silicon substrate.

### SUMMARY OF THE INVENTION

It is therefore an object of the present invention to provide a low-cost method for identifying a semiconductor device performed by using the semiconductor device itself, and a method for generating an identification code for use in that method.

A method for generating an identification code of a semiconductor device according to the present invention is a method for generating an identification code of a semiconductor device including a plurality of elements outputting logical values. The method includes the steps of: (a) obtaining logical values output from the respective elements when power is supplied to the semiconductor device; and (b) generating an identification code of the semiconductor device by using the logical values.

First logical values output after power has been supplied to a semiconductor device are greatly affected by variations in fabrication of the semiconductor device as compared to logical values output during normal operation. Accordingly, logical values unique to the respective elements constituting the semiconductor device are obtained, so that an identification code enabling more accurate identification of the semiconductor device is obtained. The identification code is obtained by using the semiconductor device itself, so that simplification and cost reduction of the identification are achieved. The obtained initial pattern code is based on variations in transistor characteristics inherently provided in the semiconductor device. Accordingly, identification information is easily obtained in any one of a wafer state, a package state after assembly and a chip state.

The method may further include the step (c) of supplying power to the semiconductor device again and obtaining logical values output from the respective elements, after the step (a) has been performed, and in the step (b), a unique code in which a logical value output from each unstable one of the elements that outputs different logical values in the steps (a) and (c) is masked may be generated as a portion of the identification code. To “mask” herein means to make an output from an unstable element “0”. In the unique code, logical values from elements always outputting “0” and logical values from unstable elements are “0”. In this case, values output from unstable elements are not reflected in the unique code, so that an identification code enabling accurate identification of even a semiconductor device including unstable elements exhibiting characteristic variations.

In the step (b), a mask code in which only the logical value output from said each unstable element is “0” may be generated as a portion of the identification code. In this case, more accurate identification is performed by using the unique code and the mask code. Specifically, AND operation of a unique code (target unique code) of a semiconductor device to be identified and a mask code for comparison (comparative mask code) is performed and AND operation of a mask code (target mask code) of the semiconductor device to be identified and a unique code for comparison (comparative unique code) is performed. The results of these operations are compared with each other, so that the semiconductor device is identified more accurately.

Before the step (a), “0” or “1” may be written in all the elements before the power is shut off and before the step (c), “0” or “1” may be written in all the elements before the power is shut off. In this case, in the step (a), unstable elements are affected by charge remaining at initialization to output “0” when “0” is written and output “1” when “1” is written. This further ensures detection of unstable elements.

In the step (b), out of the logical values obtained in the step (a) and the logical values obtained in the step (c), only the logical values in which the proportion of “1” may be a given value or higher are used to generate the unique code. In this case, the unique code is generated, while not using logical values containing a large number of “0” obtained in a case where elements have not entered a mode of reading data even after turn-on of the power, for example. Accordingly, it is possible to prevent the resultant unique code to include a large amount of “0” data.

The method may further include the step (e) of generating an intermediate identification code by using the logical values obtained in the step (a), after the step (a) has been performed and before the step (c) is performed, and in step (b), when a hamming distance between the logical values obtained in the step (c) and the intermediate identification code is equal to or smaller than a given value, the identification code may be generated by using the logical values obtained in the step (c). In this case, the identification code is generated while not using logical values which greatly differ from the other logical values. Accordingly, a more accurate identification code is obtained.

The method may further include the step (f) of generating an intermediate identification code by using the logical values obtained in the step (c), after the step (c) has been performed, and in the step (b), when a hamming distance between the intermediate identification code and the logical values obtained in the step (a) is equal to or smaller than a given value, the identification code may be generated by using the logical values obtained in the step (a). In this case, the identification code is generated while not using logical values which greatly differ from the other logical values. Accordingly, a more accurate identification code is obtained.

Each of the elements is preferably an element from which a logical value held therein is erased by turning off the power.

Each of the elements is preferably a flip-flop or an SRAM.

A method for identifying a semiconductor device according to the present invention is a method for identifying a semiconductor device by using the identification code generated by the above-described method, wherein a semiconductor device is identified by comparing a first value and a second value with each other, the first value is obtained by performing AND operation on a unique code obtained in the semiconductor device to be identified and a comparative mask code, and the second value is obtained by performing AND operation on a mask code obtained in the semiconductor device to be identified and a comparative unique code.

With this method, a semiconductor device is identified with extremely high accuracy.

The semiconductor device may be identified based on whether or not the first value and the second value are exactly the same.

The semiconductor device may be identified based on whether or not a hamming distance between the first value and the second value is equal to or smaller than a given value.

A semiconductor device according to the present invention includes: a logical value outputting circuit including a plurality of elements outputting logical values; and an identification information generating circuit for obtaining the logical values output from the respective elements and generating identification information of the logical value outputting circuit, when power is supplied to the logical value outputting circuit.

First logical values output after power has been supplied to a semiconductor device are greatly affected by variations in fabrication of the semiconductor device as compared to logical values output during normal operation. Accordingly, in the identification information generating circuit, logical values unique to the respective elements constituting the circuit are obtained. As a result, the semiconductor device enables more accurate identification.

The device may further include a mask circuit for masking a logical value from each unstable one of the elements outputting a logical value varying at every output from the logical value outputting circuit.

### BRIEF DESCRIPTION OF THE DRAWINGS

FIG. 1 is a table showing an example of an initial pattern code in which first signals output after external power has been supplied to a semiconductor device including SRAMs are arranged.

FIG. 2 shows the SRAM initial pattern code shown in FIG. 1 in the hexadecimal system.

FIG. 3 shows tables illustrating initial pattern codes of SRAMs including unstable bits and obtained n times by a method according to a first embodiment of the present invention.

FIG. 4 is a table showing a result of logical operation (AND) performed on initial pattern codes acquired n times.

FIG. 5 is a table showing a unique code of a chip.

FIG. 6 is a circuit diagram illustrating a logic circuit for implementing operation of obtaining a unique code.

FIG. 7 is a table showing a mask code of a chip.

FIG. 8 is a table showing truth values of outputs from each memory cell of a semiconductor device (inputs to an AND circuit 11 and an OR circuit 12), an output from an AND register 13, an output from an OR register 14, a unique code and a mask code, respectively.

FIG. 9 is a circuit diagram illustrating an example of a unique code comparator for automatically determining whether a semiconductor device has a specified ID code or not.

FIG. 10 is a chart for explaining an idea of a hamming distance.

FIG. 11 is a table showing truth values of a target unique code, a target mask code, a comparative unique code, a comparative mask code and a hamming distance value, respectively, in the case of identifying a semiconductor device by using the circuit illustrated in FIG. 9.

FIG. 12 is a flow chart showing steps for obtaining a unique code enabling accurate identification of a semiconductor device.

### DESCRIPTION OF THE PREFERRED EMBODIMENTS

Hereinafter, embodiments of the present invention will be described with reference to the drawings.

### Embodiment 1

Methods for identifying semiconductor devices (chips) according to the present invention are based on the following idea. In a semiconductor integrated circuit including a logic circuit or an system LSI, a large number of flip-flops, RAMs or static random access memories (SRAMs) formed by MOS processes or CMOS processes are generally provided. Each of these circuits is constituted by a plurality of MOS transistors and fabrication conditions thereof vary depending on the time, so that the transistor pattern size and the impurity diffusion concentration vary one wafer to another in a lot or depending on the position in a wafer. These variations in fabrication processes cause variations in operation output characteristics such as a variation in a threshold voltage even among transistors designed to be identical in specifications.

According to the present invention, in a semiconductor device including circuits each outputting a binary value of high (Hi)/low (Lo) (or 1/0), e.g., flip-flops, RAMs or SRAMs, variations in operation output are utilized for chip identification. Specifically, a random number pattern as a combination of first signals (bits) output from respective circuit elements after the power of a semiconductor device is turned on is used as identification information. The reason for using the first signals output immediately after the power of the semiconductor device is turned on is because variations in fabrication are more greatly reflected in these signals than in signals output during normal operation.

Since a random pattern of the output signals is used as identification information according to the present invention, it is preferable that circuits such as flip-flops, RAMs or SRAMs serving as memory cells are substantially equally likely to output Hi and Lo signals, i.e., while not leaning Hi nor Lo. Accordingly, each of such circuits is preferably constituted by elements such as transistors arranged to be electrically symmetric. In addition, in the circuits, information held until the power is turned off is preferably immediately erased by turn-off of the power. Hereinafter, a case where SRAMs are incorporated in a semiconductor device will be described as an example.

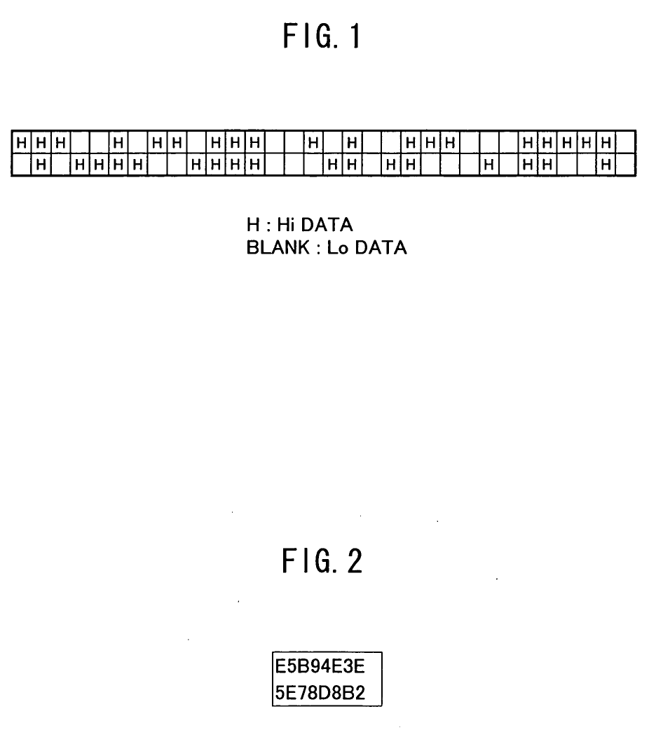

FIG. 1 is a table illustrating an example of an initial pattern code in which first signals output after the supply of external power to a semiconductor device including SRAMs are arranged. The initial pattern code is made of bits output from SRAMs as memory cells at specified addresses in the semiconductor device. In FIG. 1, 32 bits are arranged in the lateral direction of the table (bit) and 2 bits are arranged in the vertical direction of the table (word). That is, this initial pattern code is formed by 32 bits×2 words output from SRAM.

In FIG. 1, “H” represents Hi (1) data and a blank represents Lo (0) data. The combination of Hi and blanks serves as identification information unique to each semiconductor device. Operation for obtaining this identification information only needs to be performed additionally during a usual probing test using an LSI tester in a wafer state after a wafer fabricating process, for example. More specifically, it is sufficient to obtain an initial pattern code by allowing data to be output from SRAMs at specified addresses after a usual probing test, for example. The case of additionally performing operation for obtaining identification information during a usual test in this manner has an advantage in which particular preparation such as dedicated apparatus and processes is unnecessary. In FIG. 1, the pattern code is constituted by 32×2 bits. However, the present invention is not limited to this and a pattern code of another type as a combination of Hi data and Lo data may be used.

FIG. 2 shows the SRAM initial pattern code shown in FIG. 1 in the hexadecimal system. As shown in FIG. 2, the initial pattern code made of Hi and Lo is formed in the hexadecimal system, so that data capacitance of identification information is reduced. As described above, in the case of obtaining an initial pattern code during a probing test, the initial pattern code for each chip is stored in the hexadecimal system together with probing test data.

In this embodiment, an initial pattern code that is output first after the supply of power to a semiconductor device is obtained and used as an identification code. Variations in fabrication of the semiconductor device are more greatly reflected in this initial pattern code than a code obtained during normal operation. Accordingly, an identification code unique to a semiconductor device is made of outputs from circuits constituting the semiconductor device, so that the semiconductor device is identified more accurately. In this embodiment, the identification is performed by using a semiconductor device itself, so that simplification and cost reduction of the identification are achieved. The obtained initial pattern code is based on variations in transistor characteristics inherently provided in the semiconductor device. Accordingly, identification information is easily obtained in any one of a wafer state, a package state after assembly and a chip state.

### Embodiment 2

As described in the first embodiment, with a method for generating a chip identification code according to the present invention, an initial pattern code is obtained from signals output from SRAMs at specified addresses at power-on of a device and the obtained initial pattern code is used as an identification code. However, the same signal (data) is not always output from a specified address at the power-on. In particular, with respect to unstable memory cells exhibiting variations in characteristics such as transistor characteristics and memory cell electrical characteristics, outputs from these memory cells can vary, so that the output of Hi/Lo varies at every power-on in some cases. To prevent this variation, a method for ensuring identification of even a chip including such unstable memory cells is provided in this embodiment.

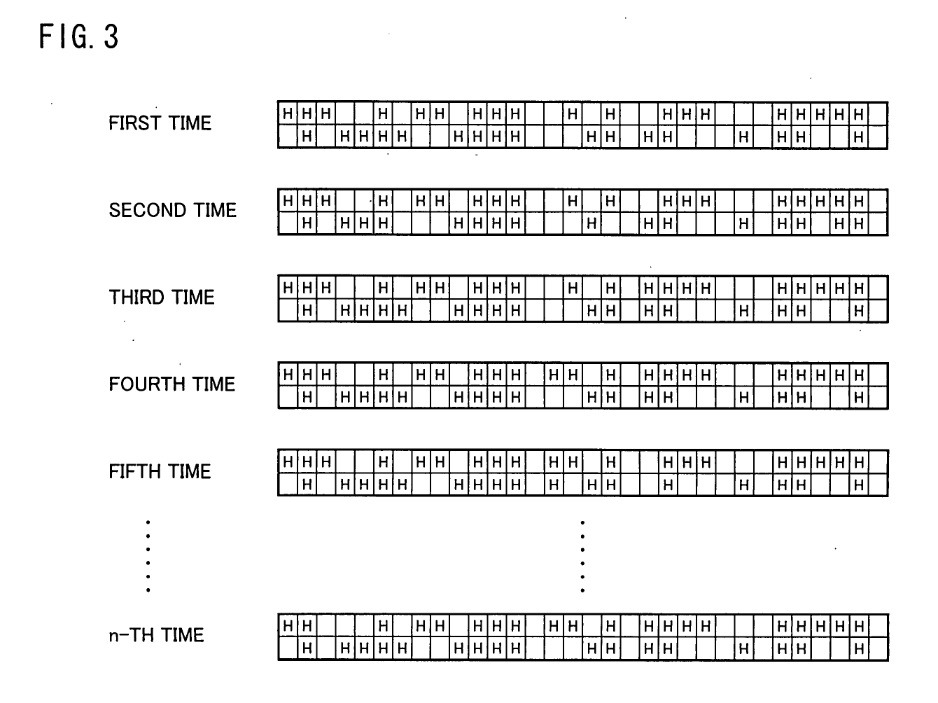

FIG. 3 shows tables illustrating n initial pattern codes repeatedly obtained by the method of the first embodiment using SRAMs including unstable ones. In the n initial pattern codes, no initial pattern codes completely match each other. In this embodiment, logical operation is performed on these initial pattern codes. More specifically, AND operation is performed on every bit in the pattern codes obtained up to the n-th time, and unstable bits are eliminated as Lo from the pattern codes.

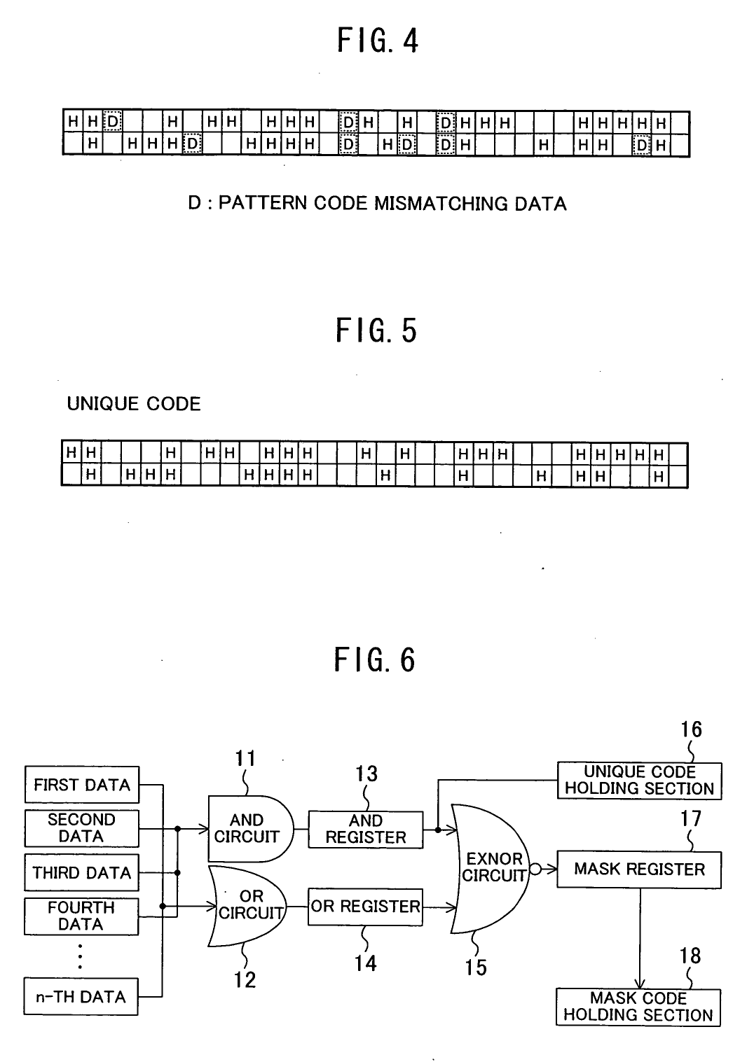

FIG. 4 is a table showing a result of logical operation (AND) performed on initial pattern codes obtained n times. The result shown in FIG. 4 is obtained by performing AND operation on the first through n-th values of each bit in the initial pattern codes shown in FIG. 3. If at least one of the first through n-th values is different from the others in a bit, operation result of this bit is Lo. The bit whose operation result is Lo is represented by “D” in FIG. 4 and defined as a pattern code mismatching bit. Thereafter, as shown in FIG. 5, pattern code mismatching bits are eliminated so that the resultant pattern code is used as a pattern code (hereinafter, referred to as a “unique code”) unique to a semiconductor device (chip). FIG. 5 is a table showing a unique code of a chip.

Operation of obtaining a unique code with the foregoing method is implemented by a logic circuit shown in FIG. 6. FIG. 6 is a circuit diagram illustrating a logic circuit for implementing operation of obtaining a unique code. In the circuit shown in FIG. 6, not only a unique code but also an accompanying code called a “mask code” is generated at the same time. The “mask code” is a code made of 32×2 bits in the same manner as a unique code and has a structure in which only unstable bits (pattern code mismatching data “D” in FIG. 4) is Lo and the other bits are Hi.

The circuit shown in FIG. 6 includes: an AND circuit 11 and an OR circuit 12 each receiving first through n-th data from each memory cell; an AND register 13 receiving an output from the AND circuit 11; an OR register 14 receiving an output from the OR circuit 12; an exclusive NOR circuit 15 receiving outputs from the AND register 13 and the OR register 14; a unique code holding section 16 holding an output from the AND register 13 as a unique code; a mask register 17 receiving an output from the exclusive NOR circuit 15; and a mask code holding section 18 holding an output from the mask register 17 as a mask code. Though each of the AND circuit 11 and the OR circuit 12 has one input in FIG. 6, n data sets from first through n-th codes are input in reality.

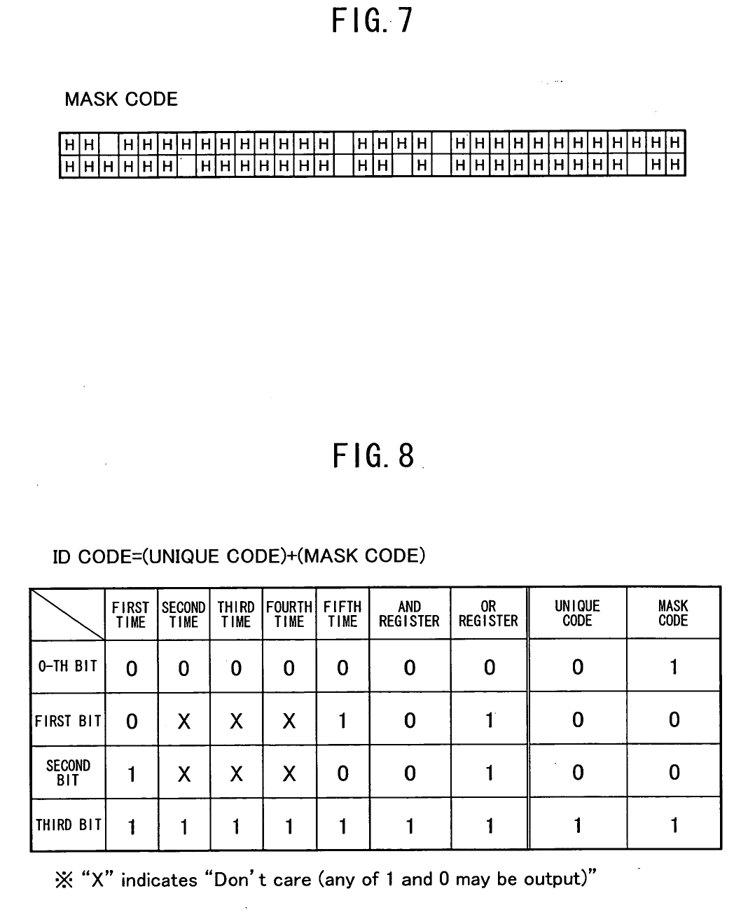

In the logic circuit shown in FIG. 6, data is input to the AND circuit 11 and also input to the OR circuit 12. Data from the AND circuit 11 is output to the unique code holding section 16 and the exclusive NOR circuit 15 via the AND register 13. At this time, the unique code shown in FIG. 5 is held in the unique code holding section 16. On the other hand, data input to the OR circuit 12 is input to the exclusive NOR circuit 15 via the OR register 14. The exclusive NOR circuit 15 outputs Hi when the outputs from the AND circuit 11 and the OR circuit 12 are the same, while outputting Lo when these outputs are different from each other. As a result, a group of bits that are output from the exclusive NOR circuit 15 and are Lo (blank) matches a group of bits represented as pattern code mismatching data “D” in FIG. 4. That is, as shown in FIG. 7, in a mask code output from the exclusive NOR circuit 15, unstable bits in the initial pattern codes are Lo and the other bits are Hi. FIG. 7 is a table showing a mask code of a chip. This mask code is an auxiliary code for determining whether a semiconductor device actually has a specified unique code or not. It will be specifically described later how to use this code. A code for use in actual identification of a semiconductor device is made of a set of a unique code and a mask code, and this set is herein referred to as “an ID code”.

The circuit shown in FIG. 6 is implemented by incorporating a program for generating an ID code in an LSI tester for obtaining initial pattern codes, for example. Alternatively, the circuit shown in FIG. 6 is formed on each semiconductor device and an initial pattern code (Hi or Lo) output from the semiconductor device may be input to a circuit placed on the semiconductor device. Alternatively, the circuit shown in FIG. 6 and the semiconductor device may be formed on different boards.

FIG. 8 is a table showing truth values of outputs from each memory cell of a semiconductor device (inputs to the AND circuit 11 and the OR circuit 12), an output from the AND register 13, an output from the OR register 14, a unique code and a mask code, respectively. This result is obtained by reading identification information five times from four memory cells, i.e., from the 0th memory cell through the third memory cells. In the line associated with 0th memory cell, “0” is output at each time in the five reading operations. In this case, the unique code is “0” and the mask code is “1”. In the lines associated with the first and second memory cells, both “1” and “0” are output in the five reading operations. In this case, the unique code is “0” and the mask code is “0”. In the table, for the first and second memory cells, “X”, which indicates “Don't care (any of “1” and “0” may be output)”, is shown as outputs from the second time to the fourth time. For each of the first and second memory cells, since the first output differs from the fifth output, the outputs of the AND register 13 and the OR register 14 are determined only by this difference. That is, the second through fourth outputs do not affect the result and, therefore, these outputs may be disregarded. Accordingly, though “0” or “1” is output in actual operation, records of these outputs are omitted. In the line associated with the third memory cell, “1” is output at each time in the five reading operations. In this case, the unique code is “1” and the mask code is “1”.

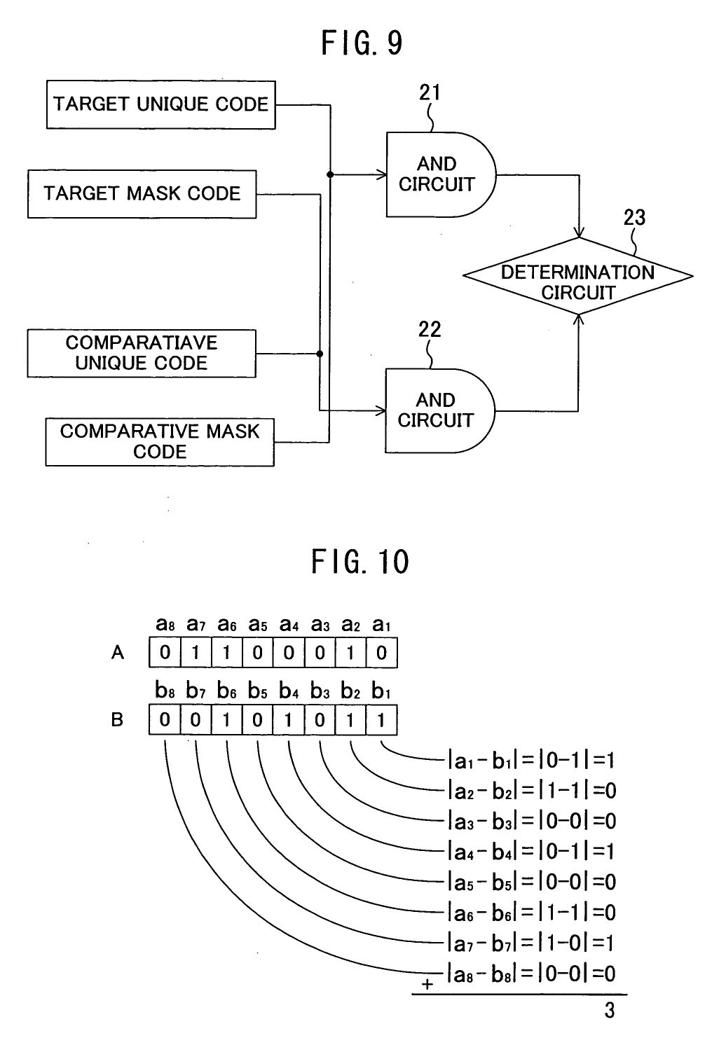

Now, it will be described how semiconductor identification (device identification) is actually performed by using an ID code obtained by the above method. FIG. 9 is a circuit diagram illustrating an example of a unique code comparator for automatically determining whether a semiconductor device has a specified ID code or not.

The unique code comparator shown in FIG. 9 includes: an AND circuit 21 receiving a target unique code and a comparative mask code; an AND circuit 22 receiving a target mask code and a comparative unique code; and a determination circuit 23 receiving outputs from the AND circuits 21 and 22. In the unique code comparator shown in FIG. 9, first, an ID code (including a target unique code and a target mask code) of a semiconductor device to be identified is acquired by the above-described method. Then, the AND circuit 21 performs AND operation on the obtained target unique code and a comparative mask code as a reference. The AND circuit 22 performs AND operation on the obtained target mask code and a comparative unique code as a reference. Thereafter, the determination circuit 23 compares output values of the AND circuits 21 and 22 with each other. The determination circuit 23 shown in FIG. 9 is a circuit for calculating a so-called hamming distance. The determination circuit 23 determines that the semiconductor device has the same ID code as the comparative code when the hamming distance is “0”, while determining that the semiconductor device does not have the same ID code as the comparative code when the hamming distance is not “0”.

Now, the hamming distance will be described. FIG. 10 is a chart for explaining an idea of the hamming distance. Suppose the output from the AND circuit 21 is a code A and the output from the AND circuit 22 is a code B, the degree of the change from the code A to the code B is represented as the distance (hamming distance) between the codes A and B. The hamming distance herein is defined as the number of bits having different values when the codes A and B are compared with each other. The hamming distance d between the codes A and B each constituted by n bits for a memory cell is represented by the following equation (1):

$$\begin{matrix}[ Equation 1 ] & \\ d = {\sum }_{i = 1}^{n} \vert {a}_{i} - {b}_{i} \vert & ( 1 )\end{matrix}$$

FIG. 10 shows a hamming distance between the codes A and B in the case of n=8. Character aᵢ denotes the value of an output from the AND circuit 21 and character bᵢ denotes the value of an output from the AND circuit 22. If the values of aᵢ and bᵢ shown in FIG. 10 are applied to Equation (1), the hamming distance in this case is determined to be three.

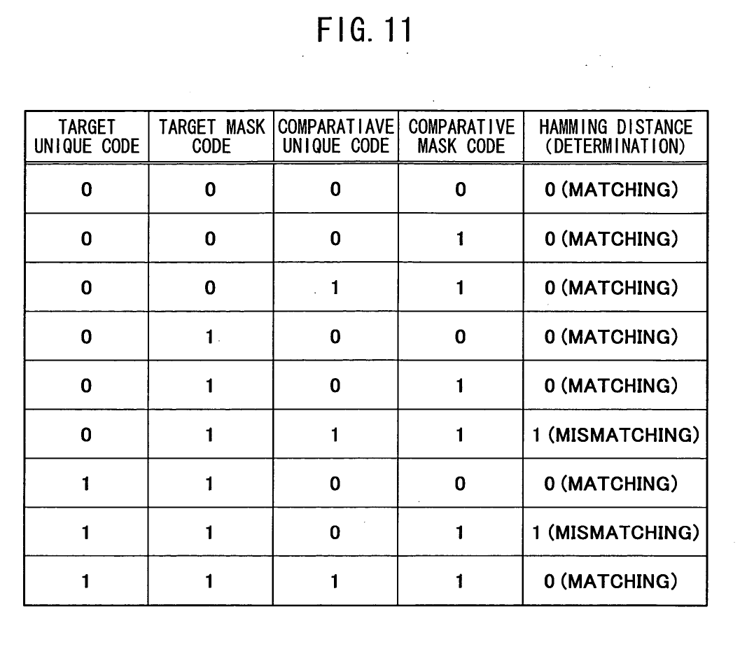

FIG. 11 is a table showing truth values of a target unique code, a target mask code, a comparative unique code, a comparative mask code and a hamming distance value, respectively, in the case of identifying a semiconductor device by using the circuit illustrated in FIG. 9. The target unique code and the target mask code are combined in three ways, i.e., (0, 0), (0, 1) and (1, 1), and the comparative unique code and the comparative mask code are also combined in three ways. Accordingly, these codes are combined in nine ways. FIG. 11 shows all these nine combinations. The hamming distance shown in FIG. 11 is calculated by using outputs each constituted by one bit, so that i=1 and n=1 in Equation (1).

In the first row in FIG. 11, the target unique code is “0” and the comparative mask code is “0”, so that the result of AND operation of the AND circuit 21 (shown in FIG. 9) is “0”. In this row, the target mask code is “0” and the comparative unique code is “0”, so that the result of AND operation of the AND circuit 22 (shown in FIG. 9) is “0”. That is, the outputs from the AND circuits 21 and 22 are both “0”. Accordingly, if aᵢ=0 and bᵢ=0 are applied to Equation (1), the hamming distance in this case is determined to be “0”. When the hamming distance is “0”, it is determined that the target code of a semiconductor device to be identified matches the comparative code. In the first row in FIG. 11, it is confirmed that the target code and the comparative code match each other. In each of the second through fifth rows and the seventh row in FIG. 11, the outputs from the AND circuits 21 and 22 are both “0”. Accordingly, the hamming distance is “0”, so that it is determined that the target code of the semiconductor device and the comparative code match each other. In the ninth row in FIG. 11, the outputs from the AND circuits 21 and 22 are both “1”. Accordingly, the hamming distance is “0” according to Equation (1), so that it is determined that the target code of the semiconductor device and the comparative code match each other.

On the other hand, in the sixth row in FIG. 11, the target unique code is “0” and the comparative mask code is “1”, so that the result of AND operation of the AND circuit 21 (shown in FIG. 9) is “0”. In this row, since the target mask code is “1” and the comparative unique code is “1”, so that the result of AND operation of the AND circuit 22 (shown in FIG. 9) is “1”. Accordingly, if aᵢ=0 and bᵢ=1 are applied to Equation (1), the hamming distance between these codes is determined to be “1”. When the hamming distance is “1”, the target code of the semiconductor device to be identified is determined not to match the comparative code. In the eighth row in FIG. 11, the output from the AND circuits 21 is “1” and the output from the AND circuit 22 is “0”. Accordingly, the hamming distance is “1”, so that it is determined that the target code of the semiconductor device and the comparative code do not match each other.

In the foregoing method, it is determined that a semiconductor device has the same code as a comparative ID code only when the hamming distance is 0, i.e., a target ID code completely matches the comparative ID code. However, some bits in an ID code can change through fabrication and packaging. Particularly in packaging, chips are heated to high temperature and subjected to stress, so that characteristics of elements constituting flip-flops or SRAMs are likely to change. For example, if a target ID code is obtained in a characteristic function test after fabricating a semiconductor substrate and the target ID code obtained after packaging of a chip is compared with the comparative ID code (i.e., target ID code after fabrication) so as to identify a semiconductor device, a hamming distance might not be zero. To avoid this, a range of the hamming distance in which it can be considered that the target ID code matches the comparative ID code is defined, and it is determined that matching is established even with respect to a hamming distance indicating mismatching as long as this hamming distance is in this range. For example, for an ID code having 64 bits, suppose matching is established when the hamming distance is equal to or smaller than 10% of the number of bits constituting the ID code. Then, it is determined that matching is established as long as the hamming distance calculated by the circuit shown in FIG. 9 is six or less.

In this embodiment, a unique code is generated from a plurality of initial pattern codes, so that unstable bits are eliminated as “0” or Lo from the unique code. This further ensures identification of even a chip including unstable memory cells.

In addition, AND operation is performed on the target unique code and the comparative mask code and AND operation is performed on the target mask code and the comparative unique code so that the hamming distance between the resultant values of these operations is calculated. As a result, the accuracy in identifying a semiconductor device is extremely high. For example, in a case where AND operation is performed on the target unique code and the comparative unique code and AND operation is performed on target mask code and the comparative mask code so as to calculate the hamming distance between the results of these operations, the percentage of accurate identification of a semiconductor device is as low as 90% to 95%. On the other hand, in the case where the target unique code and the comparative mask code are compared with each other and the target mask code and the comparative unique code are compared with each other by the method utilizing the table shown in FIG. 11, the accuracy in identifying a semiconductor device is extremely high. In this manner, with a circuit utilizing the table shown in FIG. 11, a semiconductor chip with a specific ID code is automatically selected from a large number of semiconductor chips as many as hundreds or thousands.

### Embodiment 3

In this embodiment, a method for ensuring generation of a stable ID code even when outputs from memory cells such as flip-flops or SRAMs vary through various processes such as packaging after the first ID code has been obtained.

In this embodiment, operation in which all the memory cells in a semiconductor device whose ID code is to be obtained are initialized to be “1” or “0” and then power is turned off and on again is repeatedly performed, so that an initial pattern code as shown in FIG. 3 is obtained a plurality of times. With this method, unstable memory cells are affected by charge remaining at initialization, although output “1” when all the memory cells are initialized to be “1” and output “0” when all the memory cells are initialized to be “0”. When operation is performed on the initial pattern codes obtained by using the circuit shown in FIG. 6, a unique code from which the unstable bits have been eliminated as Lo is generated. This method further ensures detection of unstable memory cells.

Some of the initial pattern codes include a large amount of Lo data. It can be considered that this is because memory cells in a semiconductor device have not entered a mode (test mode) of reading data even after the power has been turned on. If an initial pattern code including a large amount of Lo data is included in the initial pattern codes, the resultant unique code also includes a large number of Lo data, so that it is difficult to compare and identify semiconductor chips.

To avoid this difficulty, an initial pattern code (i.e., an intermediate pattern code that is not to finally become an initial pattern code) in which the number of Hi is a predetermined values or less is not adopted in operation of the circuit shown in FIG. 6 performed on initial pattern codes obtained n times, and a newly-obtained initial pattern code is used instead. The following operation may be introduced. That is, in a case where n initial pattern codes are to be obtained, an intermediate unique code is obtained by performing operation of the circuit shown in FIG. 6 at the time when i (where i<n) initial pattern codes have been obtained. Thereafter, an initial pattern code obtained at the (i+1)th time and the intermediate ID code are compared with each other. If the hamming distance between these codes is equal to or greater than a predetermined value, this initial pattern code is eliminated. In this manner, operation of the circuit shown in FIG. 6 is performed with only initial pattern codes exhibiting hamming distances of the predetermined value or less being adopted, thereby obtaining a final unique code. In this case, it is possible to generate a unique code without using a logical value greatly different from other logical values, so that a more accurate unique code is obtained. As a modified example of this method, instead of comparison between an initial pattern code that is being obtained and an intermediate ID code, i obtained initial pattern codes may be compared with a hamming distance calculated by using the (i+1)th initial pattern code.

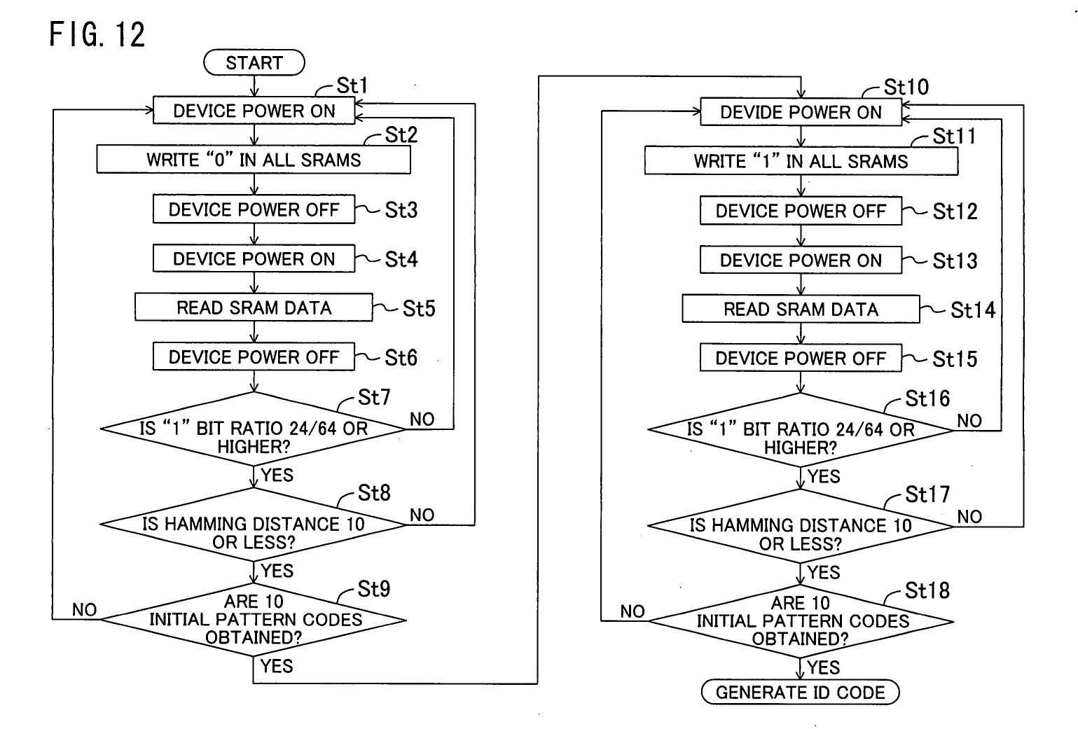

Now, steps for performing the foregoing method will be specifically described with reference to the drawings. FIG. 12 is a flow chart showing steps for obtaining a unique code enabling accurate identification of a semiconductor device. In the following description, the unique code is obtained from SRAMs. As shown in FIG. 12, at step St1, first, the power of a semiconductor device is turned on. Then, at step St2, for initialization, “0” is written in all the SRAM cells that output respective bits constituting a code, i.e., SRAM cells associated with a total of 64 bits (32 bits×2 words where 32 bits correspond to 1 word). Thereafter, at step St3, the power is turned off. Subsequently, at step St4, the power is turned on again. After an initial pattern code of the SRAMs has been read out at step St5, the power is turned off again at step St6. Then, at step St7, the ratio of bits that are Hi or “1” in the read-out initial pattern code with respect to all the bits is obtained and it is determined whether or not the ratio is 24/64 or higher. If the ratio is less than 24/64, the process returns to the first step and operation is performed again. If the ratio is 24/64 or higher, at step St8, an intermediate unique code obtained by using all the initial pattern codes obtained before this step and an initial pattern code obtained at this step are compared with each other so that the hamming distance between these codes is calculated. Then, it is determined whether or not the hamming distance is 10 or less. If the hamming distance is greater than 10, the process returns to step St1 and an initial pattern code is obtained again. If the hamming distance is 10 or less, the code used for calculating this hamming distance is used as an initial pattern code and the process proceeds to step St9. At step St9, it is determined whether or not 10 initial pattern codes have been obtained. If 10 initial pattern codes have not been obtained yet, the process returns to step St1 and a next initial pattern code is obtained. If 10 initial pattern codes have been obtained, the process proceeds to next step St10.

At step St10, the power of the semiconductor device is turned on. Subsequently, at step St11, for initialization, “1” is written in the SRAMs that output bits constituting a code. Thereafter, steps St12 through St18 are performed in the same manner as steps St3 through St9, thereby obtaining 10 initial pattern codes. Steps St12 through St18 are similar to steps St3 through St9, and description thereof is omitted. Through the foregoing steps, a total of 20 initial pattern codes are obtained. Lastly, the circuit shown in FIG. 6 performs logical operation, and the final ID code is obtained. In the ID code obtained in this embodiment, unstable bits are eliminated more precisely, so that a semiconductor device is identified more accurately.

In comparing ID codes of a large number of semiconductor devices (chips) with a specified ID code (the comparative ID code described above), IDs of the respective semiconductor devices are acquired in the manner shown in FIG. 12 and operation of the circuit shown in FIG. 9 is performed for comparison and identification. At this time, the determination circuit 23 may determine that the codes match each other when the hamming distance is “0” or when the hamming distance is equal to or less than 10% of the number of bits in a unique code.

As described above, according to the present invention, for semiconductor devices in each of which special devices such as TFTs are not incorporated but usual circuits outputting logical values of “0 (or Lo)” or “1 (or Hi)”, e.g., flip-flops or SRAMs, are incorporated, an ID code of each device is generated and individual devices are identified without the need of special circuits.

What is claimed is:

1. A method for generating an identification code of a semiconductor device including a plurality of elements outputting logical values, the method comprising the steps of:
(a) obtaining logical values output from the respective elements when power is supplied to the semiconductor device; and
(b) generating an identification code of the semiconductor device by using the logical values.

2. The method of claim 1, further comprising the step (c) of supplying power to the semiconductor device again and obtaining logical values output from the respective elements, after the step (a) has been performed,
wherein in the step (b), a unique code in which a logical value output from each unstable one of the elements that outputs different logical values in the steps (a) and (c) is masked is generated as a portion of the identification code.

3. The method of claim 2, wherein in the step (b), a mask code in which only the logical value output from said each unstable element is “0” is generated as a portion of the identification code.

4. The method of claim 2, wherein “0” or “1” is written in all the elements and then the power is shut off, before the step (a) is performed, and
“0” or “1” is written in all the elements and then the power is shut off, before the step (c) is performed.

5. The method of claim 2, wherein in the step (b), out of the logical values obtained in the step (a) and the logical values obtained in the step (c), only the logical values in which the proportion of “1” is a given value or higher are used to generate the unique code.

6. The method of claim 2, further comprising the step (e) of generating an intermediate identification code by using the logical values obtained in the step (a), after the step (a) has been performed and before the step (c) is performed,
wherein in step (b), when a hamming distance between the logical values obtained in the step (c) and the intermediate identification code is equal to or smaller than a given value, the identification code is generated by using the logical values obtained in the step (c).

7. The method of claim 2, further comprising the step (f) of generating an intermediate identification code by using the logical values obtained in the step (c), after the step (c) has been performed,
wherein in the step (b), when a hamming distance between the intermediate identification code and the logical values obtained in the step (a) is equal to or smaller than a given value, the identification code is generated by using the logical values obtained in the step (a).

8. The method of claim 1, wherein each of the elements is an element from which a logical value held therein is erased by turning off the power.

9. The method of claim 8, wherein each of the elements is a flip-flop or an SRAM.

10. A method for identifying a semiconductor device by using the identification code generated by the method of claim 3, wherein a semiconductor device is identified by comparing a first value and a second value with each other,
the first value is obtained by performing AND operation on a unique code obtained in the semiconductor device to be identified and a comparative mask code, and
the second value is obtained by performing AND operation on a mask code obtained in the semiconductor device to be identified and a comparative unique code.

11. The method of claim 10, wherein the semiconductor device is identified based on whether or not the first value and the second value are exactly the same.

12. The method of claim 10, wherein the semiconductor device is identified based on whether or not a hamming distance between the first value and the second value is equal to or smaller than a given value.

13. A semiconductor device, comprising:
a logical value outputting circuit including a plurality of elements outputting logical values; and
an identification information generating circuit for obtaining the logical values output from the respective elements and generating identification information of the logical value outputting circuit, when power is supplied to the logical value outputting circuit.

14. The device of claim 13, further comprising a mask circuit for masking a logical value from each unstable one of the elements outputting a logical value varying at every output from the logical value outputting circuit.
